(19) United States
(12) Patent Application Publication
(10) Pub. No.: US 2011/0312371 A1
(43) Pub. Date: Dec. 22, 2011

(54) Mis-function Protection Method for Mobile Phones from RF Noise Interference

(76) Inventor: Hideki Kawaji, Bedford, NH (US)

(21) Appl. No.: 12/818,244

(22) Filed: Jun. 18, 2010

(51) Int. Cl. H04W 88/02; H04M 1/00

(52) U.S. Cl. 455/550.1

(57) ABSTRACT

A mis-function protection method for mobile phones from RF noise interference includes the steps of: a signal detection circuit provided in a mobile phone, the signal detection circuit being operated to periodically detect a RF signal with a predetermined time period to determine outputting a signal; when firstly detecting no RF signal, no signal output from the signal detection circuit, alternatively when firstly detecting a RF signal, the signal detection circuit being operated to secondly detect the firstly-detected RF signal after a predetermined time; and when secondly detecting none of the firstly-detected RF signal, no signal output from the signal detection circuit, alternatively when secondly detecting the firstly-detected RF signal, the signal detection circuit being operated to output the signal.

### BACKGROUND OF THE INVENTION

1. Field of the Invention

The present invention relates to a mis-function protection method for mobile phones from RF noise interference. More particularly, the present invention relates to the mis-function protection method for mobile phones by dual or multiple identification of RF noise interference.

2. Description of the Related Art

In general, various radio frequency (RF) noises exist in ambient environment and may interfere electronic components of mobile phones (e.g. Hall IC member). These RF noises may affect normal operation of the mobile phones or result in mis-function of the mobile phones. For example, in mobile phone communication the RF noise interference may cause unexpectedly answering of the mobile phone or mis-operating other unnecessary devices.

By way of example, FIGS. 1(A)-1(C) show a series of schematic waveforms of mobile communication signals (as shown in FIG. 1A), Hall IC signal detection (as shown in FIG. 1B), and Hall IC outputting correct signals (as shown in FIG. 1C), during mobile phone transmission, in accordance with the conventional mobile communication system. Referring to FIG. 1A, the waveform of the conventional mobile communication signals has a time period of 4.6 milliseconds (ms) and the mobile communication signal has a continuous time interval of 600 microseconds (μs) during phone transmission. However, the mobile communication signals may be considered as noises for Hall IC or other electronic components. Thus, noises resulted from the mobile communication signals may interfere in normal operations of Hall IC and may cause mis-operation of Hall IC.

Referring to FIGS. 1B and 1C, the waveform of the Hall IC signal detection has a time period of 65 ms and the mobile communication signal has a continuous time interval of 180 μs, as indicated in the arrowed region in FIG. 2B. During 180 μs operation, the Hall IC can send an output signal when an electromagnetic signal received. Correspondingly, the Hall IC will not send an output signal, as shown in FIG. 1C, when no electromagnetic signal received.

Still referring to FIGS. 1A, 1B and 1C, in time series of waveforms, when the time interval of the mobile communication signal (600 μs) and that of the Hall IC signal detection (180 μs) are not matching in time series, the Hall IC will not send an output signal. In this circumstance, the mobile communication signal will be considered as not to interfere with the operation of the Hall IC.

FIGS. 2(A)-2(C) show a series of schematic waveforms of mobile communication signals (as shown in FIG. 2A), Hall IC signal detection (as shown in FIG. 2B), and Hall IC outputting incorrect signals (as shown in FIG. 2C), during mobile phone transmission, in accordance with the conventional mobile communication system. When the time interval of the mobile communication signal (600 μs) and that of the Hall IC signal detection (180 μs) are matching in time series, as indicated by two dotted lines, the Hall IC will be interfered and may send an error output signal of 0 V. In this circumstance, the mobile communication signal will be considered as a noise signal.

In order to the mis-operation of the Hall IC or other electronic components, there is a need of providing an identification method for the noise signal of the mobile communication. However, the conventional mobile phones are absent an identification method that can improve the mis-operation of the Hall IC. Hence, there exists a need of improving the conventional mobile phone for signal detection.

U.S. Pat. No. 7,358,843, entitled “Noise rejection device and cellular phone including the noise rejection device,” discloses a pillar-shaped core, a resistance film, a spiral line segment, a corresponding spiral sulcus, an oxide film, an armor and a pair of external electrodes consisted in the noise rejection device.

Furthermore, U.S. Pat. No. 7,170,37, entitled “Noise rejection device and cellular phone including the noise rejection device,” discloses a pillar-shaped core, a conductor film, a spiral line segment, a corresponding spiral sulcus, an oxide film, an armor and a pair of external electrodes consisted in the noise rejection device. U.S. Pat. Nos. 7,358,843 and 7,170,37 incorporated herein by reference for purposes including, but not limited to, indicating the background of the present invention and illustrating the state of the art.

The noise rejection device described in U.S. Pat. Nos. 7,358,843 and 7,170,37 is provided for only removing high frequency noise from a signal line, a CPU of a personal computer or a cellular phone. The high frequency noise is in a band of several hundred MHz to several GHz. However, the device of U.S. Pat. Nos. 7,358,843 and 7,170,37 cannot used to identify a noise signal for the Hall IC or other electronic components from the mobile communication.

As is described in greater detail below, the present invention provides a mis-function protection method for mobile phones from RF noise interference. A radio frequency signal received in a mobile phone component is confirmed in a dual or multiple identification process in such a way as to mitigate and overcome the above problem.

### SUMMARY OF THE INVENTION

The primary objective of this invention is to provide a mis-function protection method for mobile phones from RF noise interference. A radio frequency signal received in a mobile phone component is confirmed in a dual or multiple identification process so as to avoid functioning the mobile phone component by any RF noise interference. Accordingly, the mis-function protection method is successful in avoiding mis-function of the mobile phone component.

The mis-function protection method in accordance with an aspect of the present invention includes the steps of:

a signal detection circuit provided in a mobile phone, the signal detection circuit being operated to periodically detect a RF signal with a predetermined time period to determine outputting a predetermined signal or not;

when firstly detecting no RF signal, no signal output from the signal detection circuit, alternatively when firstly detecting a RF signal, the signal detection circuit being operated to secondly detect the firstly-detected RF signal after a predetermined time for confirmation; and

when secondly detecting none of the firstly-detected RF signal, no signal output from the signal detection circuit, alternatively when secondly detecting the firstly-detected RF signal, the signal detection circuit being operated to output the predetermined signal.

In a separate aspect of the present invention, the mis-function protection method includes the steps of:

a signal detection circuit provided in a mobile phone, the signal detection circuit being operated to periodically detect a RF signal with a predetermined time period to determine outputting a predetermined signal or not;

when firstly detecting no RF signal, no signal output from the signal detection circuit, alternatively when firstly detecting a RF signal, the signal detection circuit being operated to secondly detect the firstly-detected RF signal after a first predetermined time for confirmation;

when secondly detecting none of the firstly-detected RF signal, no signal output from the signal detection circuit, alternatively when secondly detecting the firstly-detected RF signal, the signal detection circuit being operated to thirdly detect the firstly-detected RF signal after a second predetermined time for confirmation; and

when thirdly detecting none of the firstly-detected RF signal, no signal output from the signal detection circuit, alternatively when thirdly detecting the firstly-detected RF signal, the signal detection circuit being operated to output the predetermined signal.

In a further separate aspect of the present invention, the signal detection circuit includes a Hall sensor member.

In yet a further separate aspect of the present invention, the predetermined time period is 65 ms.

In yet a further separate aspect of the present invention, the first predetermined time is 1.5 ms.

In yet a further separate aspect of the present invention, the second predetermined time is 1.5 ms.

In yet a further separate aspect of the present invention, the predetermined signal is used to actuate a control circuit provided in the mobile phone.

In yet a further separate aspect of the present invention, the control circuit includes a phone-answering module.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1(A)-1(C) are a series of schematic waveforms of mobile communication signals, Hall IC signal detection, and Hall IC outputting correct signals, during mobile phone transmission, in accordance with the conventional mobile communication system.

FIGS. 2(A)-2(C) are a series of schematic waveforms of mobile communication signals, Hall IC signal detection, and Hall IC outputting incorrect signals, during mobile phone transmission, in accordance with the conventional mobile communication system, which is similar to FIG. 1.

FIG. 3 is a schematic circuitry of a control unit applied in a mis-function protection method for mobile phones from RF noise interference in accordance with a preferred embodiment of the present invention.

FIGS. 4(A)-4(C) are a series of schematic waveforms of mobile communication signals, Hall IC's signal detection, and Hall IC outputting correct signals generated by the mis-function protection method, during mobile phone transmission, in accordance with the preferred embodiment of the present invention.

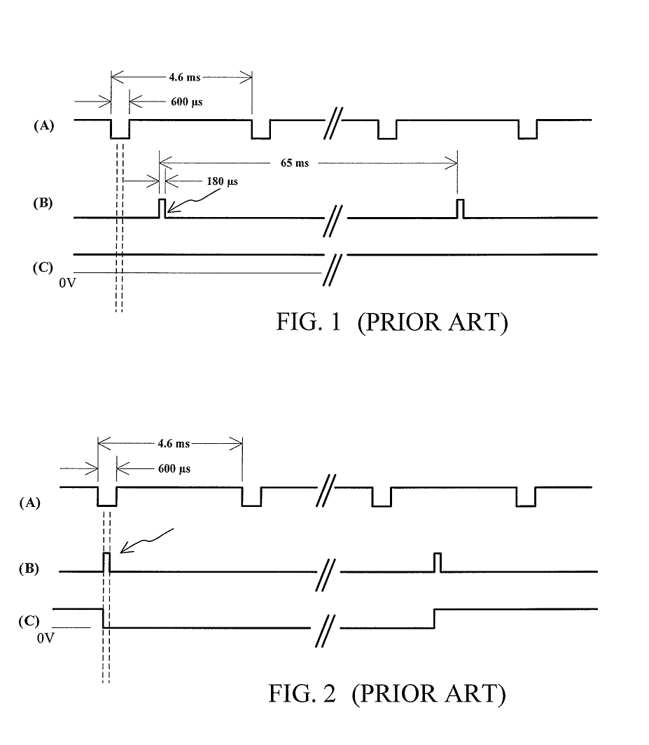

### DETAILED DESCRIPTION OF THE INVENTION

It is noted that a mis-function protection method for mobile phones from RF noise interference in accordance with the preferred embodiment of the present invention is suitable for various mobile phone systems, for example, including PHS (Personal Handy-Phone System), CDMA (Code Division Multiple Access), GSM (Global System for Mobile Communication) and GPRS (General Packet Radio Service) which are not limitative of the present invention.

FIG. 3 shows a schematic circuitry of a control unit applied in the mis-function protection method for mobile phones from RF noise interference in accordance with a preferred embodiment of the present invention. Referring to FIG. 3, a control unit includes a Hall sensor unit 11, an operational amplifier (OP AMP) unit 12, a comparator unit 13, a first latch unit 141, a second latch unit 142, an OR gate unit 15, a transistor switch unit 16, a logic circuit unit 17, a clock unit 18, a counter unit 19, a first monostable multivibrator 201, a second monostable multivibrator 202 and a third monostable multivibrator 203.

With continued reference to FIG. 3, the Hall sensor unit 11, the operational amplifier unit 12, the comparator unit 13, the first latch unit 141, the second latch unit 142, the OR gate unit 15, the transistor switch unit 16 and the logic circuit unit 17 are electrically connected and used to supply a control signal. Furthermore, the clock unit 18, the counter unit 19, the first monostable multivibrator 201, the second monostable multivibrator 202 and the third monostable multivibrator 203 are electrically connected and used to supply a clock signal to the first latch unit 141, the second latch unit 142 and the logic circuit unit 17.

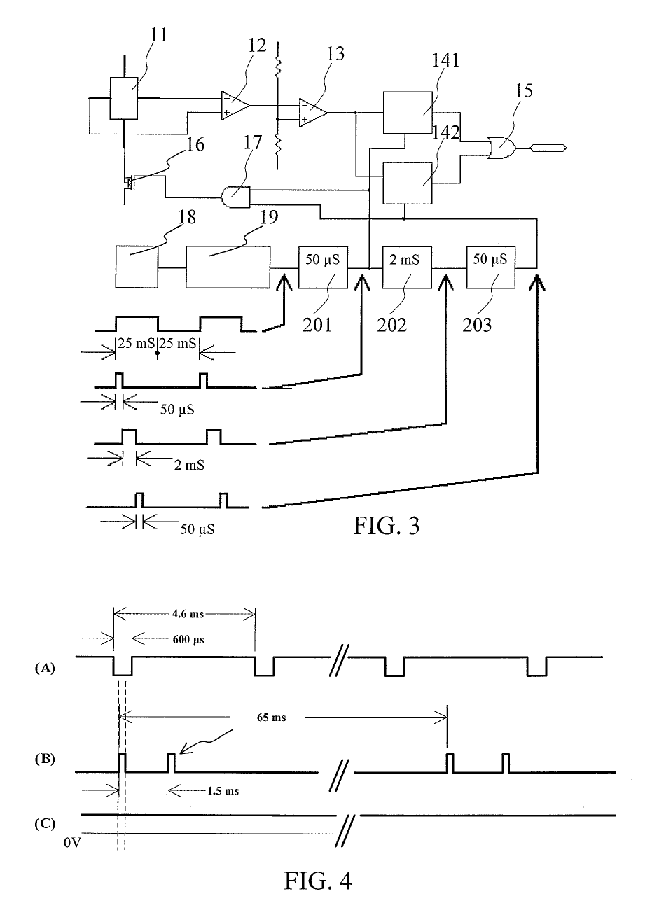

Turning now to FIGS. 4(A)-4(C) are, a series of schematic waveforms of mobile communication signals (as shown in FIG. 4A), Hall IC's signal detection (as shown in FIG. 4B), and Hall IC outputting correct signals (as shown in FIG. 4C) generated in the mis-function protection method in accordance with the preferred embodiment of the present invention are shown.

Referring to FIGS. 4(A)-4(C), the mis-function protection method of the present invention includes the step of: a signal detection circuit provided in a mobile phone, the signal detection circuit being operated to periodically detect a RF signal with a predetermined time period (e.g. 65 ms) to determine outputting a predetermined signal or not. The predetermined signal has a relative reference of 0 Volt. In a preferred embodiment, the signal detection circuit includes a Hall sensor member.

Still referring to FIGS. 4(A)-4(C), the mis-function protection method of the present invention further includes the step of: when firstly detecting no RF signal, no signal output from the signal detection circuit, alternatively when firstly detecting a RF signal, as indicated by two dotted lines, the signal detection circuit being operated to secondly detect the firstly-detected RF signal, as indicated in the arrowed region in FIG. 4B, after a predetermined time (e.g. 1.5 ms) for confirmation.

Still referring to FIGS. 4(A)-4(C), the mis-function protection method of the present invention further includes the step of: after passing the predetermined time of 1.5 ms, when secondly detecting none of the firstly-detected RF signal, no signal output from the signal detection circuit, alternatively when secondly detecting the firstly-detected RF signal, the signal detection circuit being operated to output the predetermined signal. In this preferred embodiment, the mis-function protection method for mobile phones of the present invention utilizes dual identification of RF signal for avoiding RF noise interference.

In a preferred embodiment, the predetermined signal is used to actuate a control circuit provided in the mobile phone. By way of example, the control circuit may include a phone-answering module which is not limitative of the present invention.

In another preferred embodiment, the mis-function protection method for mobile phones of the present invention may utilize triple or multiple identification of RF signal for avoiding RF noise interference without departing from the present invention.

For example, the mis-function protection method includes the steps of: a signal detection circuit provided in a mobile phone, the signal detection circuit being operated to periodically detect a RF signal with a predetermined time period to determine outputting a predetermined signal or not;

when firstly detecting no RF signal, no signal output from the signal detection circuit, alternatively when firstly detecting a RF signal, the signal detection circuit being operated to secondly detect the firstly-detected RF signal after a first predetermined time for confirmation;

when secondly detecting none of the firstly-detected RF signal, no signal output from the signal detection circuit, alternatively when secondly detecting the firstly-detected RF signal, the signal detection circuit being operated to thirdly detect the firstly-detected RF signal after a second predetermined time for confirmation; and

when thirdly detecting none of the firstly-detected RF signal, no signal output from the signal detection circuit, alternatively when thirdly detecting the firstly-detected RF signal, the signal detection circuit being operated to output the predetermined signal.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. A mis-function protection method for mobile phones from RF noise interference during phone transmission, comprising the steps of:
a signal detection circuit provided in a mobile phone, the signal detection circuit being operated to periodically detect a RF signal with a predetermined time period to determine outputting a predetermined signal or not;
when firstly detecting no RF signal, no signal output from the signal detection circuit, alternatively when firstly detecting a RF signal, the signal detection circuit being operated to secondly detect the firstly-detected RF signal after a predetermined time for confirmation; and
when secondly detecting none of the firstly-detected RF signal, no signal output from the signal detection circuit, alternatively when secondly detecting the firstly-detected RF signal, the signal detection circuit being operated to output the predetermined signal.

2. The mis-function protection method as defined in claim 1, wherein the signal detection circuit includes a Hall sensor member.

3. The mis-function protection method as defined in claim 1, wherein the predetermined time period is 65 ms.

4. The mis-function protection method as defined in claim 1, wherein the predetermined time is 1.5 ms.

5. The mis-function protection method as defined in claim 1, wherein the predetermined signal is used to actuate a control circuit provided in the mobile phone.

6. The mis-function protection method as defined in claim 5, wherein the control circuit includes a phone-answering module.

7. A mis-function protection method for mobile phones from RF noise interference during phone transmission, comprising the steps of:
a signal detection circuit provided in a mobile phone, the signal detection circuit being operated to periodically detect a RF signal with a predetermined time period to determine outputting a predetermined signal or not;
when firstly detecting no RF signal, no signal output from the signal detection circuit, alternatively when firstly detecting a RF signal, the signal detection circuit being operated to secondly detect the firstly-detected RF signal after a first predetermined time for confirmation;
when secondly detecting none of the firstly-detected RF signal, no signal output from the signal detection circuit, alternatively when secondly detecting the firstly-detected RF signal, the signal detection circuit being operated to thirdly detect the firstly-detected RF signal after a second predetermined time for confirmation; and
when thirdly detecting none of the firstly-detected RF signal, no signal output from the signal detection circuit, alternatively when thirdly detecting the firstly-detected RF signal, the signal detection circuit being operated to output the predetermined signal.

8. The mis-function protection method as defined in claim 7, wherein the signal detection circuit includes a Hall sensor member.

9. The mis-function protection method as defined in claim 7, wherein the predetermined time period is 65 ms.

10. The mis-function protection method as defined in claim 7, wherein the first predetermined time is 1.5 ms.

11. The mis-function protection method as defined in claim 7, wherein the second predetermined time is 1.5 ms.

12. The mis-function protection method as defined in claim 7, wherein the predetermined signal is used to actuate a control circuit provided in the mobile phone.

13. The mis-function protection method as defined in claim 12, wherein the control circuit includes a phone-answering module.
